(19) United States
(12) Patent Application Publication
(10) Pub. No.: US 2010/0159852 A1
(43) Pub. Date: Jun. 24, 2010

(54) Wireless Home

(76) Inventor: James Kakaire, Binghamton, NY (US)

Correspondence Address: BROWN & MICHAELS, PC;400 M & T BANK BUILDING, 118 NORTH TIOGA ST, ITHACA, NY, 14850, US

(21) Appl. No.: 12/716,336

(22) Filed: Mar. 3, 2010

Related U.S. Application Data
(63) Continuation of application No. PCT/US2008/010406, filed on Sep. 6, 2008.
(60) Provisional application No. 60/967,793, filed on Sep. 7, 2007.

(51) Int. Cl. H04B 1/38

(52) U.S. Cl. 455/90.2

(57) ABSTRACT

A multipurpose transceiver based on internet protocol addressing, designed in conjunction with two different satellite dish antenna setups one wireless and the other wired. The transceiver receives signals such as radio or microwaves from space satellites, cell towers, surveillance cameras and transmitters at specified frequencies and utilizes the different frequency ranges to process input and output. Services include television, wireless home phone, Internet, fax service, surveillance camera service, real time video, real time train, ship or boat location, real time airplane cockpit audio, flight data and geographical location of plane in terms of coordinates for timely search and rescue. The system also collects data from environmental data delivery sensors. A combination of two or more of frequency range, address, system identification numbers and phone number deters unauthorized access to service.

### RELATED APPLICATIONS

This is a continuation patent application of PCT application serial number PCT/US2008/010406, filed Sep. 6, 2008, entitled, “WIRELESS HOME”, which claims priority from U.S. provisional patent application Ser. No. 60/967,793, filed Sep. 7, 2007, now abandoned. The benefit under 35 USC §119(e) of the United States provisional application is hereby claimed, and the aforementioned applications are hereby incorporated herein by reference.

### FEDERALLY SPONSORED RESEARCH

Not Applicable

### SEQUENCE LISTING OR PROGRAM

Not Applicable

### BACKGROUND OF THE INVENTION

1. Field of Invention

The system improves current satellite based dish service for providing television broadcasts. In addition to television, this system provides Internet service, fax, surveillance camera data, data from transmitters and voice via separate wires in the signal collecting horn. This is accomplished in conjunction with a transceiver comprising of a circuit board and at least one processor. The transceiver receives signals at different frequencies and decodes it to suit intended devices. A transceiver is used instead of a receiver to allow for bidirectional flow of data, hence enabling addressing and wireless networking of devices and mufti device usage.

2. Prior Art

Currently, satellite dishes are mounted on top of buildings and wires are extended from the dish to a receiver and then other wires are extended from the receiver to TV sets. The number of TV sets is limited to two or so. It is very difficult to install the service in most places, so it is undesired by many would be customers due to the drilling that has to be done to all walls. This invention eliminates those problems and introduces new services utilizing a transceiver which is a two way data transfer device.

### OBJECTS AND AVANTAGES OF THE INVENTION

Unlike current systems that only provide television, this invention enables access to cell towers in addition to space satellites. The current system provides television service, wireless home phone, surveillance camera service, real time video, fax, transmitter data collection and computer data to be received and allows voice, video, fax and computer data to be sent out wirelessly via transceivers. This is accomplished by using computer communication network and a transceiver that provides bidirectional data instead of receivers used in the current satellite based television systems.

The present invention allows for wireless distribution of signals from within a building. In one version, a wireless dish with built in transceiver is located outside. In the other version, a main transceiver indoors connected by wires, distributes data wirelessly to other transceivers connected by addressing. Devices such as routers that feed computers are physically connected to transceivers. Alternatively, a router is built into a transceiver. This wireless combination eliminates the need for drilling through walls to run wires, which is a cumbersome process and sometimes impossible and hence the wireless combination provides more services.

Under the current system, some rooms in a building where a customer would want to place a television may not be accessible with the receivers that are based on drilling through walls.

Wireless distribution of data within a building, makes it easy for technicians to install the service, cuts costs and hence attracts more customers. Transceivers wirelessly transmit data to other transceivers which in turn provides data to devices without drilling.

Remote controls are not user friendly when satellite signal is lost for any reason. Several steps have to be taken to restore satellite mode. A one step button restores television mode and vice versa in this invention.

Using a button on remote control or transceiver; TV mode turns off all transceiver functionality but lets power flow through transceiver such that TV works without pressing several buttons. Satellite mode connects to the satellite by pressing one button as shown in the flow chart of FIG. 5. This is accomplished by means of software that issues commands to reset all operations to satellite mode, TV mode or defaults to a choice of interest.

For the wireless programmable dish with a built in transceiver as shown in FIG. 3, multiple user devices can be connected to one dish without any wires, but by an addressing mechanism. Similarly, the main transceiver in the second version gets data through wires and then avails data wirelessly to other devices. Best of all, the system provides services without telephone poles and wires on the streets. An optional wire outlet is built into the wireless satellite dish antenna to allow basement floors to receive signals that wouldn't otherwise.

Each of the transceivers inside the buildings receives data from the dish antenna but sends out going data directly without sending it through the dish antenna outside.

Many different devices are wirelessly connected to the transceivers, unlike in the current satellite based television service where receivers are restricted to a few wired televisions.

With a solar panel, remotely located users may be able to get a wireless home phone, Internet and television without electricity from major companies.

Many people now days don't subscribe to land line phones. Unlike existing systems that track location of dishes by land phone lines, a dish or transceiver with an address such as internet protocol (IP), can be easily tracked wirelessly and provide useful information such as location and number of devices connected to the dish or main transceiver since all transceivers used are addressed. All service administration is remotely carried out by a service provider. The present invention also enables a user to logon from a remote location and monitor their surveillance cameras or view recorded data.

The present invention eliminates the costly need for running and maintaining wires over telephone poles by allowing usage of wireless home phones and is friendly to the ecosystem since it saves trees.

The present invention enables real time electronic collection of climatic or weather data from environmental data delivery transmitters on land or large water bodies for analysis and storage. The present invention also enables collection of data from surveillance cameras into transceivers via dish antenna.

### BRIEF DESCRIPTION OF THE DRAWINGS

A complete understanding of this invention may be obtained by reference to the accompanying drawings, when taken in conjunction with the detailed description thereof in which:

FIG. 1 shows chart of data flow from source to destination. This involves data source, satellite or cell tower, satellite dish antenna and transceivers that exchange data.

FIG. 2 shows wired version of the satellite dish and how it passes data. The transceiver works as a wireless access point unlike in the wireless embodiment, where the satellite dish works as the wireless access point. Outgoing data is sent from each of the transceivers independently to cell towers, satellite or other without going through the satellite dish antenna.

FIG. 3 shows wireless version of satellite dish. This version is programmable with a built-in transceiver and interacts with devices such as a wireless access point. It is loaded with a transmitter, repeater, amplifier and other devices that help it propagate data without signal degradation. Like the transceiver in the wired version, the wireless version of dish antenna can send data out as well as the transceivers depending on strength of transmitters and repeaters built into the transceivers. The wireless dish antenna in this figure has an optional wire outlet for allowing service to basement floors where waves may sometimes not reach properly.

FIG. 4 shows how the main transceivers in both wired and wireless version authenticating other devices.

FIG. 5 shows a one button touch on a remote control or transceiver that enables the system to get into desired mode in one step by means of software. Desired mode may be television, satellite, surveillance camera or other.

FIG. 6 shows a general data flow diagram where data source such as television service center, end users data, transmitters in airplanes and water vessels that locates airplanes and water vessels at all times provides data to each other. The data source shows operation data, transmitters on land and water for environmental data transmitting to satellite and cell towers. The data source also shows how surveillance cameras transmit data directly to satellite dish antennas at a specified frequency to get downloaded and recorded in the transceiver and attached external drives or computers.

FIG. 7 shows a control center used to monitor data from locator transmitters. This is comprised of multiple computer screens and servers where data from locater devices in airplanes, ships or boats is downloaded and analyzed.

### DRAWINGS REFERENCE NUMERALS

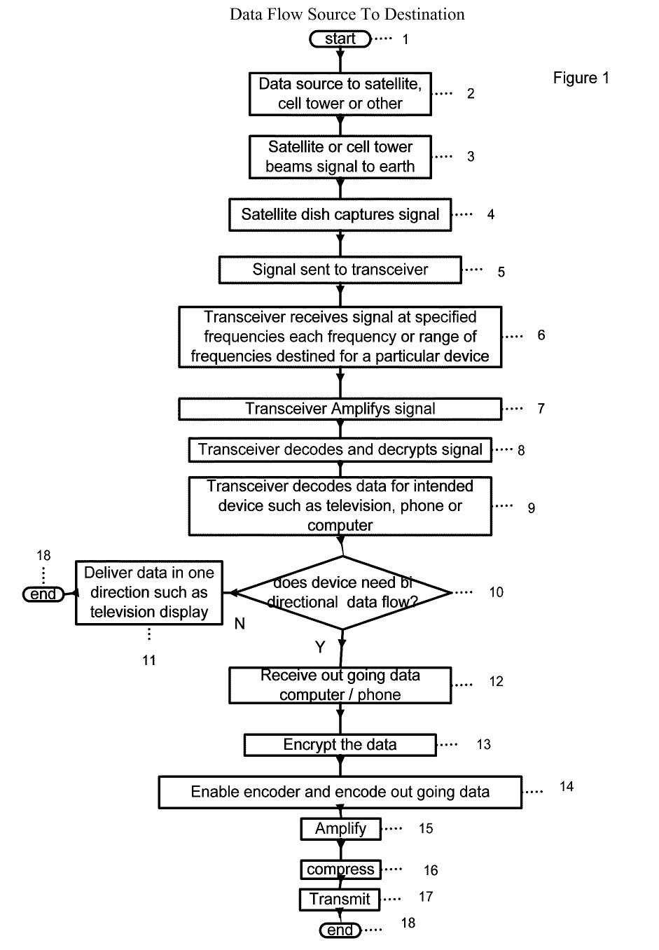

FIG. 1: FIG. 1 shows data flow from source to destination 1-18

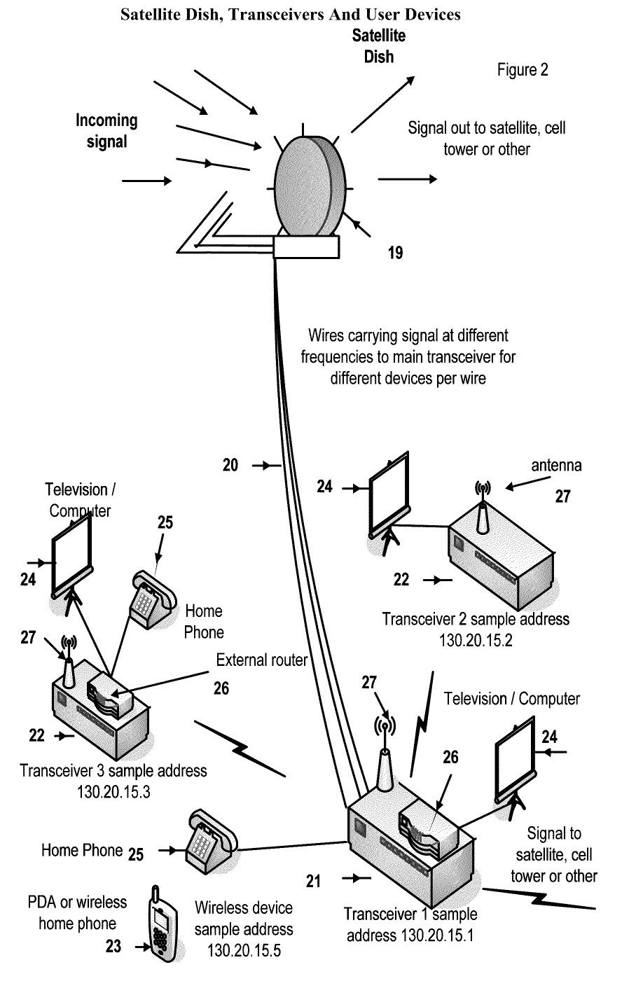

FIG. 2: Under FIG. 2, 19 is the wired dish antenna, 20 represents connecting wires, 21 is the main transceiver and 22 are secondary transceivers. Further, 23 is a wireless home phone, 24 represents devices such as computers and television, 25 is a phone plugged into a transceiver 26 is a router or switch and 27 is an optional antenna.

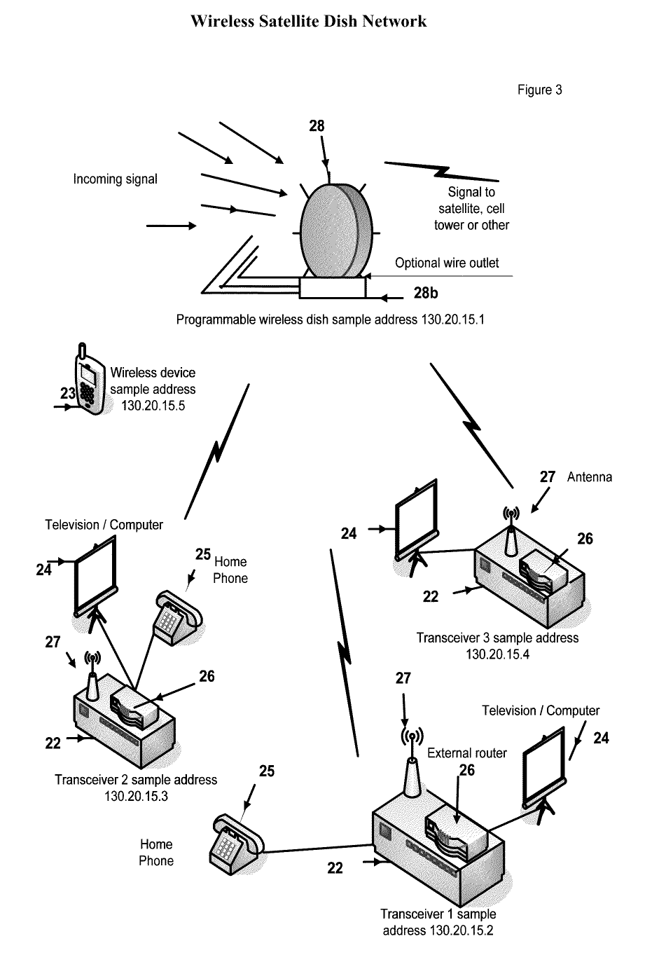

FIG. 3: Under FIG. 3, 28 is a wireless dish antenna utilized as a data access point, 22 represents transceivers, 23 is a wireless home phone, 24 represents data devices such as computers and televisions, 25 is a telephone and 26 is a router or switch to which user data devices are connected.

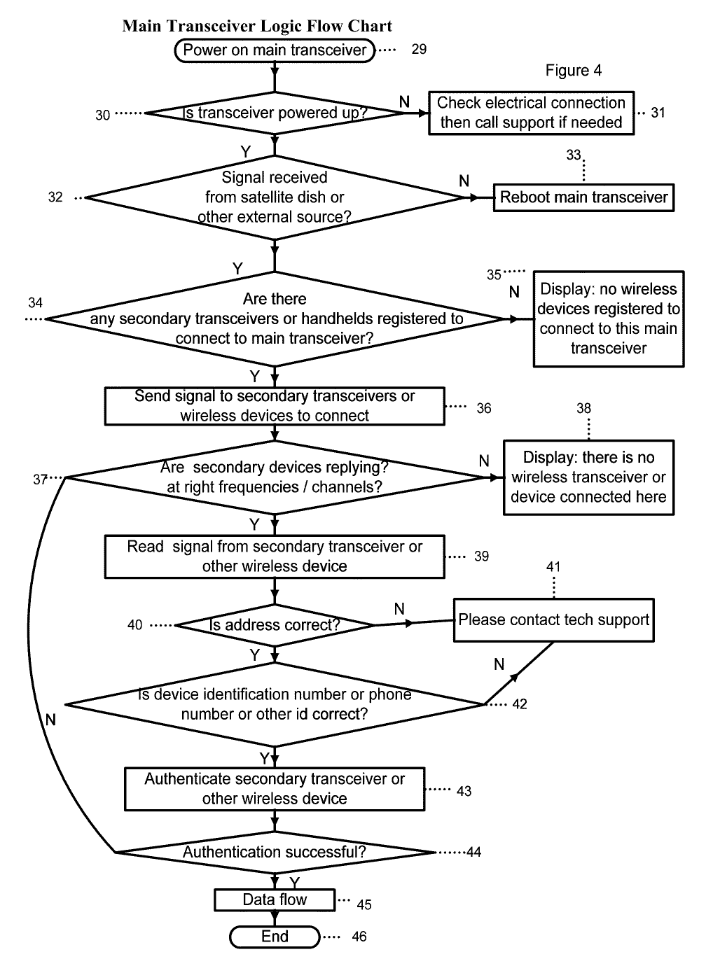

FIG. 4: FIG. 4 represents functionality of the transceiver 29-46.

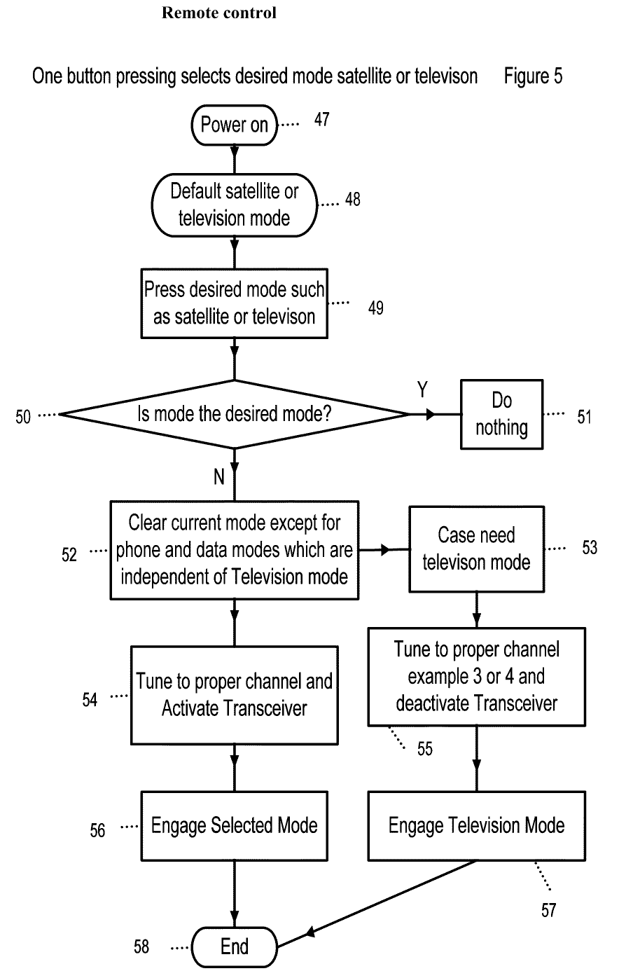

FIG. 5: FIG. 5 shows functionality of television remote control 47-58.

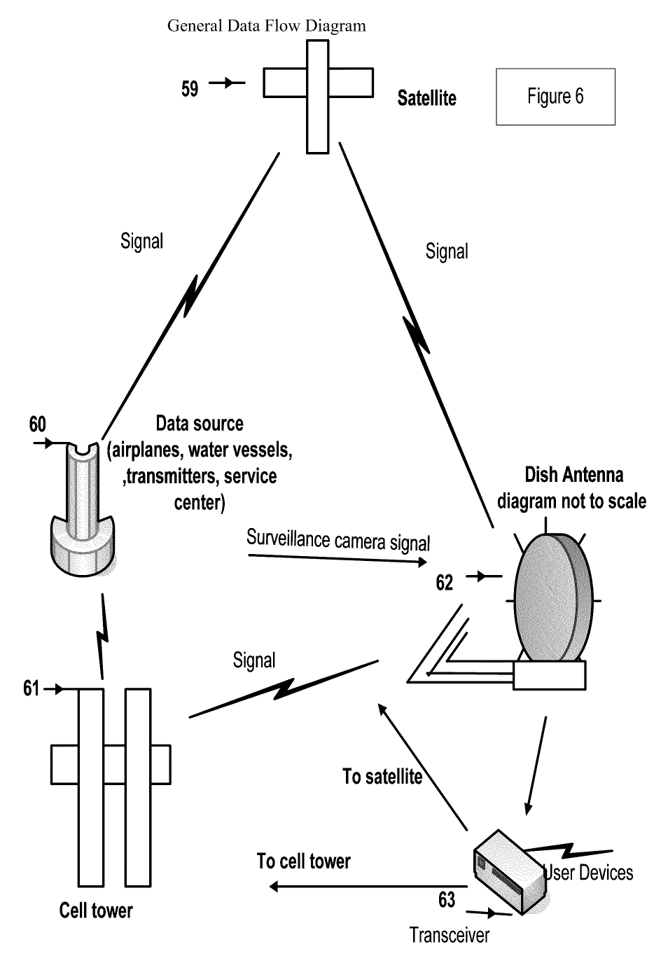

FIG. 6: Under FIG. 6, 59 is a space satellite, 60 represents data source, 61 is a cell tower, 62 is a dish antenna and 63 is a transceiver.

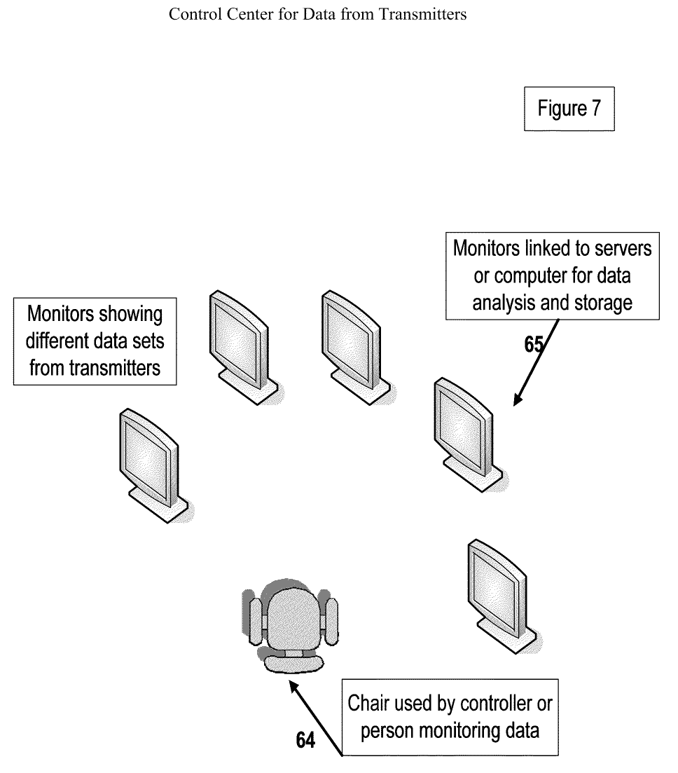

FIG. 7: Under FIG. 7, 64 is seat for the person monitoring data and 65 is a combination of monitors and computers or servers.

### DETAILED DESCRIPTION OF PREFERRED EMBODIMENT

A satellite dish antenna with two versions: wired as shown in FIG. 2 and wireless as shown in FIG. 3 with a built in transceiver 28b, 19 receives signals and uses a wireless mechanism or wires 20 to transfer signal from space satellites 59, cell towers 61, surveillance cameras and transmitters 60 to transceiver(s) 63 as shown in FIG. 6. Fax, real time video, voice and data are also transferred back from transceivers to cell nodes or space satellites.

For the wired version of this system as shown in FIG. 2, there are two options. The satellite dish 19 collects signals and passes the signals onto the main transceiver 21 through wires 20. A wire(s) 20 from the satellite dish antenna 19 is set to pass signals to a particular processor chip that decodes only specific frequencies. That is, wire(s) 20 sends signals to a chip that decodes the signals into TV programming. Another wire(s) 20 from the dish 19 runs along the first wire, and sends a signal to a different chip within the transceiver for the transceiver to decode the signals into data for computers or televisions 24. Another wire(s) gets to the transceiver and data from that range of frequencies, is decoded into voice for a home telephone 25 and so on. Since there is a processor chip for each wire(s) and frequency range, all devices that is, television, computer, phone, fax, surveillance cameras, real time video and transmitters work independently.

Alternatively, under FIG. 2, data from the satellite dish antenna 19 goes through one wire 20 to the main transceiver 21. The transceiver 21 then filters out noise or unwanted data, and splits the signal according to frequency, amplifies, decodes and sends it to user devices or wirelessly to other transceivers 22 in the building.

A transceiver 21 is made to receive TV programming signal, Internet data, voice, fax, surveillance camera, real time video, transmitters or all of the above from a satellite dish antenna 19. This transceiver with an address such as internet protocol (IP), allows entry of addresses of other devices that connects through it wirelessly.

These addresses are entered via a built in mini keyboard, an externally connected full size keyboard through a port such as Universal Serial Bus (USB), or an externally connected device that one logs on and synchronizes intended addresses of devices with the ones in the transceiver to allow other devices connect to that transceiver and allow removal of devices that are discontinued.

The main transceiver in this case 21 works like a wireless access point, but restricts connectivity only to devices whose addresses are entered into the main transceiver or devices physically connected to the transceiver such as a router or switch for computer(s). The main transceiver is loaded with a repeater that amplifies the signal to prevent degradation during wireless transmission.

The main transceiver 21 also works as a subnet on a network from which similar addresses are extended to other transceivers in the vicinity and authenticates as described in steps 29-46 of FIG. 4, those other transceivers 22 by means of addressing such as internet protocol (IP) or other means capable of wirelessly authenticating, and receiving and sending a signal. It is by this addressing mechanism that the main transceiver is identified when it transmits data. However, transceivers may also be identified by phone number, system identification number (SIN) or physical addresses.

When secondary transceivers 22, whose addresses are stored in the main transceiver 21 are turned on, they look for a signal from the main transceiver, to supply their address to the main transceiver 21 for authentication and the main transceiver 21 verifies the address and other data and then allows connection and data exchange.

The transceivers 21, 22, 28b are made to transmit data so that they can allow interactivity needed by the Internet connected computer, fax, real time video or home phone. A transceiver is made with a filter for eliminating noise from needed signal.

To allow for communication between a transceiver, computers 24 and mobile devices such as PDA's 23, routers or switches 26 are physically connected to a transceiver 22. The router or switch 26 connected to a transceiver may be wireless or not. On the way in, the transceiver decodes data and encodes it on the way out as shown in FIG. 1, steps 8-14. Some or all of the data is encrypted and compressed to maximize data security and minimize transmission time as shown in FIG. 1, steps 13-17.

The transceivers 21, 22, 28b may have one, two or more processor chips for decoding and encoding at different frequencies and at least three modes of television 24, Internet 24, real time video, surveillance camera, transmitter and telephone 25. The phone mode is always on regardless of whether any other mode is on. Users have to press a button on the transceiver or remote control to select between television and Internet or any other mode. However, all may be available at the same time since processing of each is independent.

A call placed from a wireless home phone 23, 25 is identified by cell towers 61 or satellite 59 by phone number. When a call is placed to a wireless home phone, it is received by all of the transceivers in other rooms since the phone number is configured into all the transceivers.

One frequency may be used for a zero value in binary and another frequency may be used for a one in binary data format.

To help reduce interference and let multiple devices use the same wireless connection simultaneously, the system may frequently hop or jump between frequencies.

A transceiver 21, 22, 28b may send outgoing data at one frequency or a range of frequencies and may receive data at different frequencies in order to distinguish between the incoming, see steps 4-11 and outgoing data, see steps 10-18. It assigns a unique code to data on encoding and it is this unique code that is used to decode the data at destination.

The wireless version of dish antenna 28 is powered by solar rechargeable batteries. However, electricity, solar panels or any other kind of energy may be used to power the dish. The dish detects low battery by means of a sensor and sends signal to the television or computer to advise the change of the battery.

The wireless satellite dish 28 takes addresses of transceiver(s) to connect to it and store the addresses in memory. Addresses are either entered via a water proofed mini keyboard mounted on the dish antenna or preferably via an externally connected device through a slot or data port such as USB. The dish continually transmits signal it receives.

The transceivers 22 receive signals from the dish antenna 28 and decodes the signals according to frequency and then distributes the signals to other electronic devices connected to the transceiver such as televisions 24, phones 25, routers or switches 26 for computers and fax machines.

The wireless dish 28 with built in transceiver 28b or main transceiver 21 in the wired version, wirelessly transmits data such as system identification number, addresses of devices connected to it and phone number to a service provider for identification. The physical street address where dish is located and number of transceivers or devices connected to the satellite dish or main transceiver in the wired version can also be transmitted to the service provider, since all transceivers are addressed and any activated port on transceiver is reported.

A service provider is able to login remotely and administer the transceiver, trouble shoot and upgrade software. Similarly, a user may login for recorded videos or current camera recordings.

In the case of a regular none interactive dish antenna, wires are extended to the transceiver and the transceiver wirelessly distributes data to other transceivers and electronic devices.

### Operation of Apparatus

Each transceiver 21, 22 is provided with an electronic serial number programmed into it as a distinguishing feature. It gets an address such as internet protocol (IP) for networking. A phone number also connects the transceivers to the cell towers or satellite for service.

Each phone line uses at least two frequencies one for talking and the other for listening.

A phone connected to a transceiver dials out through the transceiver and it is the main transceiver 21 that is identified by the service provider though the phone number also displays for further identification.

Transceivers 21, 22, 28b may have battery backups to allow them operate in absence of electricity thereby enabling telephone usage in emergency situations. However, different versions of transceivers may be produced to have all the seven, six, five, four, three, two or just one of TV, Computer, fax, surveillance camera, phone, real time video or transmitter service.

When powered, the secondary transceiver 22 provides its identification number and address to the main transceiver 21.

Powering up the main transceiver 21 connected to dish antenna 19, it looks for responses from devices with addresses in its storage. A transceiver whose address is not in the main transceiver 21 and whose communication frequency range is different is not authenticated to get service. This main transceiver 21 then distributes signal wirelessly to the secondary transceivers 22. The secondary transceivers 22 may also feed televisions 24, phones 25 and routers or switches 26 for computers. Similarly, transceivers transmit data out to cell towers, space satellites and other destinations.

The main transceiver 21 exchanges data with other transceivers 22 within a building wirelessly, but devices such as televisions, phones and others may be connected to the other transceivers 22 directly using wires.

The transceiver 22 as shown in FIG. 3 with the wireless version of satellite dish antenna may have a repeater, both a low power transmitter for low altitude data transmission that enables signal to propagate to cell towers, and a high power transmitter to enable transmission to space satellites. One or both transmitters may be used with radio or microwaves.

Transmitters built into transceivers 21, 22, 28b may be made with specifications of low frequency of 3-30 MHz and one above 30 MHz.

The transceiver receives outgoing data from devices such as phones computers, fax machines or handhelds via internal or external routers 26. The routers 26 encode, amplify, and encrypt the data when necessary, and transmit the data to cell nodes 61, space satellites 59 or other mediums that further propagates data to final destination as shown in FIG. 6. Transmitted data may include voice, internet data, fax and video.

Transceivers 21, 28b receives incoming data, decodes 8, 9, amplifies 7, and distributes the incoming data to user devices in the vicinity through steps 10, 11 44, 45, 46 as shown in FIGS. 1 and 4.

The transceiver 21, 22, 28b caches the last television channel viewed in cache memory and provides it whenever the user turns on TV or wants to retreat after changing to a different channel.

The wireless satellite dish antenna 28 with a built in transceiver 28b and memory serves as a subnet providing addresses for secondary equipment whose addresses are stored in the transceiver.

The wireless dish antenna 28 with a built in transceiver 28b and main transceiver in wired version 21 works like wireless access points and distributes signal to secondary electronic devices such as transceivers 22 whose addresses are stored in the main transceivers and whose communication frequency range is specified. The dish then transmits data to secondary transceivers 22. Secondary transceivers exchange data with user devices and transmits directly to cell towers, space satellites or other without going through the wireless satellite dish 28.

By means of software instructions shown in FIG. 5, with steps 47-58, a television remote control is instructed to reset the system or combination of transceiver/television with one touch of a button to return to satellite mode when the signal is lost for any reason. This is in addition to regular functions of a remote control. A button on the transceiver also accomplishes the same.

A transceiver 21, 22, 28b is designed in conjunction with an environmental data delivery transmitter to download environmental data for analysis and storage. This data collector and transmitter referred to as environmental data delivery is detailed in Applicant's published application no. US 2008/0300790, published Dec. 4, 2008, entitled, “Environmental Data Delivery—EDD” and is hereby incorporated by reference.

The transceivers 21, 22, 28b have built in security, such that a combination of two or more of frequency range, unique addresses, system identification numbers and phones, see steps 34-43 of FIG. 4, are stored in the main transceiver 21 for the wired version or stored in the wireless satellite dish 28b to deter unauthorized access.

Each service, TV, phone, fax, video, and data may have a dedicated chip to process that particular service without interfering any other service that may be in use. From a circuit board, wires connect each processor chip to the horn such that each chip receives a specific range of frequencies to process a different data set.

A transceiver 21, 28b with five processors would have at least five data transfer wires each connected to a specific processor to speed up processing time and prevent interference of one service with another. Incoming data is flagged to distinguish it from out going data while data intended for different devices is distinguished by frequency. Flags may be a combination of binary zeros and ones.

Encryption takes place when data is being beamed to space satellite or cell tower by service provider or at the customer transceiver level as shown in steps 10-18 of FIG. 1 and decryption takes place at customer level. However, there is an option of not encrypting data at all for faster processing.

Each antenna 19, 28 has a horn with one or more wires to gather signal and direct the signal to the chip responsible for the intended service by filtering and only picking out range of frequencies intended for a particular service.

In case of a processor chip that has to process more that one type of service, the transceiver peeks at the header of the data packet and determines by means of software what kind of service to receive and what device to send data stream to.

Transmitters located in airplanes and other locations sends data to satellite or cell towers and data is in turn broadcast as waves to be received by the transceiver via dish antenna and destined for computers or servers, TV, or other medium for storage, analysis and archiving.

A device 60 is designed in conjunction with a transceiver 63 to collect and transmit data in real time to a control center as shown in FIG. 7, via satellite 59 and dish antenna 62 to locate moving objects such as airplanes, ships, boats and trains as a means to locate the objects for a timely search and rescue in case of accidents.

Data from device also helps control the number of airplanes in the sky.

Data from the locater transmitters in airplanes and water vessels such as ships or boats comprises geographical coordinates of plane location (x, y, z) at any given time, flight information and cockpit audio. This may be stored for a very short time. Once a plane or ship gets to final destination, data may be discarded to provide for memory.

Transmitter 60 directs data to space satellites wherein satellite beams the same to dish antenna 62 at control center as shown in FIG. 7 on Earth.

Dish antennae 19, 28 are located in an open area where signals can easily be received. This includes top of buildings.

The dish antennae placed on ships, boats and other moving vessels rotates automatically to face direction of satellite for best quality signal at all times. Rotation is accomplished by utilizing a compass that always points to the north and a sensor to direct the dish to the desired direction

A repeater is built into the transceiver 21, 28b to boost the signal so as to enable propagation of data out to the cell towers and the space satellite as well as data out to other transceivers within a building. Routers 26 and other user devices are directly plugged into the transceiver using wires. However, a router or switch may be built into the transceiver to prevent having too many devices.

The transceivers 21, 22, 28b enable recording of incoming data to external hard drives connected via ports such as universal serial bus. The drives are selectable at recording by aid of driver software. The hard drive can then be plugged to a computer and transfer data to other storage medium in a mode compatible with the region of operation for video. Using buttons on the remote control or the transceiver, transceiver driver software installed gives options to select a drive and record in different regional playback modes.

The transceivers 21, 22, 28b are built with several data in/out ports such as universal serial bus (USB) and video audio out to allow for multiple hard drives to be plugged into transceiver to store data. Each drive may record one particular surveillance camera, locater, environmental data transmitter or video program for a prolonged recording. A user gets access to stored data from remote location via the Internet by logging into an addressed transceiver.

Driver Software is loaded into the transceiver to allow it recognize the external hard drives. Software also allows real time and scheduling of a recording through a remote control or manually on the transceiver.

The hard drives for external data recording can be plugged into computers or similar devices after recording to transfer data to other removable storage mediums.

Data sets processed by transceivers 21, 28b includes incoming television programming, incoming video/audio from surveillance cameras, incoming data from stationed transmitters such as Environmental Data Delivery and mobile transmitters such as airplane and water based vessel locators, incoming/out going fax and phone data and real time video over internet protocol.

A processor in this application refers to a data processing chip which receives data via wires and electronic circuit and processes it according to instructions.

A transceiver 21, 22, 28b is identified by an unique address such as internet protocol (IP), which facilitates connection to the Internet and enables remote administration of services offered.

The transceiver 21, 22, 28b also has an internal unique identifier. The main transceiver 21, 28b is manufactured with all capabilities but secondary transceivers 22 are scaled down depending on services needed. For a customer to get service, at least one of the following services has to be enabled in the transceiver: Satellite based television; Wireless home phone; Wireless fax service; Real time video exchange; Surveillance camera video/audio; Transmitter capture/locaters; and Computer data (environmental, internet or other) each transmitted at specific frequencies.

A range of frequencies is established for each type of data set as follows. Frequency ranges are symbolically represented here by alphabetical characters, but in production they are ranges represented by numerical digits.

| | |
|---|---|
| Television: | aa-bb |
| Phone: | cc-dd |
| Computer Data: | ee-ff |
| Fax: | gg-hh |
| Surveillance cameras: | ii-jj |
| Transmitters: | kk-ll |
| Real time video | mm-nn |

A combination of two or more of frequency range, address, system identification number and phone number deters unauthorized access.

The transceiver 21, 22, 28b has a driver installable in computers to make it recognized by computers as a plug and play drive so as to exchange data in two directions and enable recording onto computers. The transceiver driver may be embedded into computer operating systems during development of operating system to make it a plug and play device.

The transceiver 21, 22, 28b enables transfer of data recorded on the built in hard drive to other medium through video in video out and audio in audio out interfaces as well as Universal Serial Bus (USB) ports.

Recording directly onto computers is enabled by a cable that has video audio in/out at one end and USB port on the other side in conjunction with transceiver driver installed on the computer.

The transceiver driver software enables scheduled recording and real time recording. After recording of data, software gives options of regional play back format such as NTSC, PAL etc.

The transceiver 21, 22, 28b enables selection of data destination drive to schedule recording. For internal recording or removable hard drive recording, one uses touch buttons or remote control. For recording to a computer, users may utilize transceiver software installed on a computer and schedule recordings from the computer.

A locater device with sensors, is designed in conjunction with a transceiver to collect data about moving objects such as airplanes, ships and boats and transmit data in real time to a control center via satellite and dish antenna. The dish antenna is operatively connected to a transceiver to enable download of data onto computers or servers in a control center.

Data from locator devices prevents collision of trains by informing all parties involved.

Locaters are mounted in airplanes, ships, boats and trains to collect and transmit data. Data collected includes flight information, cockpit audio and geographical coordinates (X,Y,Z) of the plane, water vessel or train at any given time. Where X stands for latitude, Y longitude and Z altitude respectively.

Collected data saved in files, databases or data structures helps in an effort to locate these objects in a timely manner during search and rescue operations after accidents

The control center as shown in FIG. 7 is comprised of multiple computers, servers and storage mediums 65 where data from locater devices in airplanes, ships or boats is downloaded and analyzed. A chair 64 is utilized by personnel monitoring data.

### CONCLUSION

The present invention includes satellite dish service that combines television service, Internet service, voice, fax, real time video exchange, camera service and transmitters into one service for convenience. The present invention makes satellite service available to more people and eliminates the costly need for running wires over telephone poles, reducing the usage of trees. This system also helps with obtaining climatic data from transmitters stationed in various places including water bodies such as oceans that would be difficult to obtain. The main transceiver of the system gets data from satellite dish then distributes the data wirelessly to addressed transceivers. This eliminates the need for drilling through walls, making satellite television service more likable and easy to install while giving more options and better service.

1. An interactive dish antenna comprising:
at least one signal collecting horn;
a built in transceiver coupled to the horn for receiving signals from space satellites, cell towers, surveillance cameras, transmitters and other sources, encrypted or not, at multiple ranges of frequencies; and
a wireless mechanism coupled to the transceiver to propagate the signals to user devices and transceivers.

2. The dish antenna of claim 1, further comprising at least one data processing chip to process different kinds of data collected from the signals and means for identifying incoming and outgoing flagged data packets identified for TV service, fax service, internet service, video service, wireless telephone service, surveillance camera, transmitters and transceivers to allow each of the services to function independent of one another so that using one may not affect the other.

3. The dish antenna of claim 2, wherein the transceiver sends the outgoing flagged data packets identified for TV service, fax service, internet service, video service, wireless telephone service, surveillance camera, transmitters and transceivers directly to the devices without sending the data packets through the dish antenna.

4. The dish antenna of claim 1, further comprising a cable outlet, a built in repeater, and transmitter(s) for data propagation including means for identification such as an internet protocol (IP) address which is uniquely identified to exchange data with other devices and acts as a wireless access point to authenticate other transceivers while using the internet protocol address to act as a subnet on a network to provide a range of addresses for other transceivers to which user devices are connected to communicate and exchange data.

5. The dish antenna of claim 4, wherein the range of addresses for other transceivers are stored in memory.

6. The dish antenna of claim 1, further comprising a cable outlet, a built in repeater, and transmitter(s) for data propagation including means for identification such as phone number, system identification number or physical address.

7. The dish antenna of claim 1, wherein the transceiver further comprises
at least one processor; and
a built in repeater to boost an outgoing signal to receive data signals from the dish antenna via wires, whereby each wire carries at least one range of frequencies from the at least one signal collecting horn in the dish antenna to a data processing chip within the transceiver as a means for processing different kinds of data sets including television, internet, phone, fax, surveillance cameras, real time video and transmitters.

8. The dish antenna of claim 7, wherein the signal is identified by a unique internet protocol (IP) address to enable a service provider to perform remote administration on the transceiver, whereby the service provider provides instructions for termination or restoration of service, upgrade or downgrade of service and wherein all necessary information exchange is performed remotely via radio or microwave signals while allowing a customer or a person getting service to login from a remote location via internet and access recorded videos from surveillance cameras or current sessions of surveillance camera recordings.

9. The dish antenna of claim 7, wherein the transceiver receives data from space satellites, cell towers, transmitters and surveillance cameras in a form of radio waves or microwaves via antenna, decodes the data for user devices while encoding out going data with unique identifiers or flags to distinguish between incoming and outgoing data and then propagates the data to cell towers, space satellites and other transceivers in the vicinity depending on configuration.

10. The dish antenna of claim 7, further comprising:
at least one internal hard drive,
at least one universal serial bus port for externally connecting devices such as hard drives to enable recording of data both in and outside,
at least one audio and video in-out interface to enable data exchange with different devices; and
a software driver that enables real time and scheduled recording to selectable drives;
such that recorded video data is converted to regional play back modes of choice by the software driver.

11. The dish antenna of claim 10, wherein the at least one hard drive is plugged into a computer after video data is recorded to transfer the recorded video data to other hard drives.

12. The dish antenna of claim 7, further comprising built in security to be used as a main transceiver which acts as a subnet on a network to provide local addresses for other transceivers in a vicinity and authenticates those other transceivers to provide service to user devices such as televisions, wireless home phones, fax machines and computers and provides a means for switching between a television mode, a satellite mode and other modes of operation by pressing one button on the transceiver itself or a remote control.

13. The dish antenna of claim 1, further comprising a plurality of video in-out and audio in-out interfaces to allow for transfer of data between the transceiver and other devices while simultaneously recording from security cameras and transmitters to external hard drives without interference.

14. The dish antenna of claim 1, further comprising: a plurality of universal serial bus (USB) ports to allow for utilization of multiple plug and play hard drives as means for data recording and storage, such that a surveillance camera, a locater device or a transmitter records to a single external drive for a prolonged period of time while providing users access to stored data from a local or a remote location via internet or intranet by authentication.

15. A dish antenna comprising:
a multi-processor transceiver; and
a data collecting horn having multiple data transfer wires each connected to a specific processor chip via a circuit board within the multi-processor transceiver;
such that processing of different kinds of incoming and outgoing data sets broadcast at different ranges of frequencies is enabled to suit different kinds of services and devices while preventing interference between the different kinds of incoming and out going data sets.

16. The dish antenna of claim 15, wherein the multi-processor transceiver sends the outgoing data sets for different kinds of services and devices are sent directly to the devices without sending the outgoing data sets through the dish antenna.

17. The dish antenna of claim 15, wherein the dish antenna is placed on ships, boats and other moving vessels to rotate automatically basing on direction of the moving vessel to face a direction of space satellite for best quality signal at all times.

18. The dish antenna of claim 15, further comprising a mechanism for encrypting, decrypting and decoding data beamed from a service center, internet or transmitters via cell towers or satellites and data from surveillance cameras or local transmitters directly from local waves to user devices via the transceiver.

19. The dish antenna of claim 15, further comprising a means for routing data to a secondary transceiver which also routes data to devices physically connected to them to provide at least one service consisting of television service, internet service, phone service, fax service, surveillance camera service, real time video service or transmitter data collection.
